(19) United States
(12) Patent Application Publication
(10) Pub. No.: US 2007/0036383 A1
(43) Pub. Date: Feb. 15, 2007

(54) Earbud Protection Systems

(76) Inventor: Joseph Dean Romero, Phoenix, AZ (US)

Correspondence Address: STONEMAN LAW OFFICES, LTD, 3113 NORTH 3RD STREET, PHOENIX, AZ, 85012, US

(21) Appl. No.: 11/463,832

(22) Filed: Aug. 10, 2006

Related U.S. Application Data
(60) Provisional application No. 60/707,890, filed on Aug. 12, 2005.

(51) Int. Cl. H04R 25/00

(52) U.S. Cl. 381/380; 381/370

(57) ABSTRACT

A system related to improved protective coverings for ear-bud-type speaker devices. The system includes a shaped elastic cover that is structured and arranged to envelope substantially the entire earbud speaker housing. A consumer kit and methods of use and fabrication are also disclosed.

### CROSS-REFERENCE TO RELATED APPLICATION

The present application is related to and claims priority from prior provisional application Ser. No. 60/707,890, filed Aug. 12, 2005, entitled “EAR BUD PROTECTION SYSTEMS”, the content of which is incorporated herein by this reference and is not admitted to be prior art with respect to the present invention by the mention in this cross-reference section.

### BACKGROUND

This invention relates to earbud protection systems. More specifically, this invention relates to providing a system for improved protective coverings for earbud-type speaker devices.

Portable audio/media devices (e.g., digital audio/media players, compact disc players, AM/FM stereo players) often utilize “earbud” audio speakers. Earbuds are small speaker devices that are worn partially engaged within the ear of the user. These audio devices are often used during rigorous physical activities where both the user and device experiences considerable dynamic forces (such as during running, racket sports, mountain biking, etc.).

Earbuds most often comprise a plastic housing surrounding a sound-generating speaker. The speaker portion of most plastic housings benefit from the application of a covering to assist in retaining the bud within the ear of the user and to provide a level of comfort during use. Hypothetically, such covers would be constructed of a material that is non-abrasive to the skin of the ear. Unfortunately, a covering that engages a sufficient portion of the earbud device to maintain the positioning of the device during use does not currently exist. Furthermore, no covering currently exists that has sufficient durability to remain usefully functional over time. Without careful design and construction, cover elements are easily dislodged from the plastic bud, resulting in loss of the cover element. Without the cover element, the earbud becomes difficult to fit to the ear and is objectionably uncomfortable to most users.

### OBJECTS AND FEATURES OF THE INVENTION

A primary object and feature of the present invention is to overcome the above-mentioned problems.

It is a further object and feature of the present invention to provide a system for protective covering of an earbud speaker that is resistant to dislodging and loss during use and storage.

It is a further object and feature of the present invention to provide such a system that envelops substantially the entire earbud housing assembly.

It is another object and feature of the present invention to provide such a system that closely conforms to the outer shape of the earbud device.

It is a further object and feature of the present invention to provide such a system that accommodates the passage of sound through the covering membrane.

It is another object and feature of the present invention to provide such a system that comprises visual-association features such as colors, patterns, logos, etc.

It is a further object and feature of the present invention to provide such a system as a kit.

It is another object and feature of the present invention to provide an efficient method of construction.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system related to covering at least one earbud-type audio headphone, structured and arranged to convert at least one electric signal to at least one audible sound wave, wherein such at least one earbud-type audio headphone comprises at least one speaker housing comprising at least one inner-ear portion and at least one outer-ear portion, such system comprising: cover means for substantially covering the at least one inner-ear portion and the at least one outer-ear portion of the at least one speaker housing; wherein such cover means comprises interior compartment means for interiorly receiving at least one substantial portion of the at least one inner-ear portion and the at least one outer-ear portion, access aperture means for providing aperture access to such interior compartment means, shape conformer means for substantially conforming such cover means to at least one outer shape of the at least one speaker housing, and sound wave propagator means for propagating at least one portion of the at least one audible sound wave through such cover means.

Moreover, it provides such a system wherein: the at least one earbud-type audio headphone comprises at least one wire structured and arranged to conduct the at least one electrical signal externally of the at least one speaker housing; and such cover means further comprises wire cover means for covering at least one portion of such at least one wire. Additionally, it provides such a system wherein the at least one inner-ear portion and the at least one outer-ear portion are removably contained within such interior compartment means. Also, it provides such a system wherein such cover means further comprises visual coordinator means for visually coordinating such cover means to at least one other visual element. In addition, it provides such a system wherein such cover means further comprises indicia means for providing visually discernable indicia.

In accordance with another preferred embodiment hereof, this invention provides a system related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, such system comprising: at least one cover structured and arranged to cover substantially the entire at least one inner-ear portion and the at least one outer-ear portion of the at least one speaker housing; wherein such at least one cover comprises at least one interior compartment structured and arranged to interiorly contain at least one portion of both the at least one inner-ear portion and the at least one outer-ear portion, at least one access aperture structured and arranged to provide aperture access to such at least one interior compartment, at least one shape conformer structured and arranged to substantially conform such at least one cover to at least one outer shape of the at least one speaker housing, and at least one sound-wave propagator structured and arranged to propagate at least one portion of the at least one audible sound wave through such at least one cover.

Moreover, it provides such a system wherein: the at least one earbud-type audio headphone comprises at least one wire structured and arranged to conduct the at least one electrical signal to within the at least one speaker housing; and such at least one interior compartment is structured and arranged to cover at least one portion of such at least one wire. Additionally, it provides such a system wherein such at least one interior compartment comprises at least one substantially flexible outer membrane structured and arranged to substantially surrounds such at least one interior compartment.

Also, it provides such a system wherein such at least one sound-wave propagator comprises at least one sound passing aperture structured and arranged to assist passage of the at least one audible sound wave through such at least one substantially flexible outer membrane. In addition, it provides such a system wherein such at least one substantially flexible outer membrane comprises at least one molded unit comprising at least one synthetic rubber. And, it provides such a system wherein such at least one substantially flexible outer membrane comprises at least one substantially elastic fabric.

Further, it provides such a system wherein such at least one substantially flexible outer membrane comprises at least one outer foam covering structured and arranged to externally cover at least one portion of the at least one inner-ear portion. Even further, it provides such a system wherein such at least one cover is pre-formed to generally match at least one outer shape of such at least one earbud-type audio headphone. Moreover, it provides such a system wherein such at least one cover further comprises associating indicia structured and arranged to visually associate such at least one cover to at least one other visual element.

In accordance with another preferred embodiment hereof, this invention provides a system related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, such system comprising: at least one cover structured and arranged to substantially cover the at least one inner-ear portion and at least one outer-ear portion of the at least one speaker housing; wherein such at least one cover comprises at least one substantially elastic outer membrane structured and arranged to substantially conform to at least one peripheral shape of the at least one speaker housing; wherein such at least one substantially flexible outer membrane defines at least one interior compartment; wherein such at least one interior compartment comprises at least one access aperture structured and arranged to provide aperture access to such at least one interior compartment; and wherein such at least one cover comprises at least one pre-formed shape structured and arranged to generally match at least one outer shape of such at least one earbud-type audio headphone.

Additionally, it provides such a system wherein such at least one pre-formed shape comprises: at least one first region within such at least one interior compartment structured and arranged to generally match at least one outer shape of the at least one inner-ear portion of the at least one earbud-type audio headphone; and at least one second region within such at least one interior compartment structured and arranged to generally match at least one outer shape of the at least one outer-ear portion of the at least one earbud-type audio headphone. Also, it provides such a system wherein such at least one first region is structured and arrange to conform to a disk shape having an outer radius of about one-quarter inch.

In addition, it provides such a system wherein such at least one second region is structured and arrange to conform to a cylindrical shape having an outer diameter of about one-quarter inch. And, it provides such a system wherein such at least one second region further comprises: at least one frictional retainer structured and arranged to assist frictional retention of such at least one cover on the at least one earbud-type audio headphone; wherein such at least one frictional retainer comprises at least one friction-generating band structured and arranged to frictionally engage at least one outer circumferential surface of the at least one outer-ear portion. Further, it provides such a system further comprising such at least one earbud-type audio headphone.

In accordance with another preferred embodiment hereof, this invention provides a kit system related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, such kit system comprising: at least one cover structured and arranged to substantially cover the at least one inner-ear portion and the at least one outer-ear portion of the at least one speaker housing; at least one set of user instructions; and at least one package structured and arranged to contain such at least one cover and such at least one set of user instructions; wherein such at least one cover comprises at least one interior compartment structured and arranged to interiorly receive at least one substantial portion of the at least one inner-ear portion and the at least one outer-ear portion, at least one access aperture structured and arranged to provide aperture access to such at least one interior compartment, at least one shape conformer structured and arranged to substantially conform such at least one cover to at least one outer shape of the at least one speaker housing, and at least one sound-wave propagator structured and arranged to propagate at least one portion of the at least one audible sound wave through such at least one cover.

Even further, it provides such a kit system according claim 16 wherein such at least one cover further comprises coordinating indicia structured and arranged to visually coordinate such at least one cover to indicia associated with at least one other visual element. Moreover, it provides such a kit system according claim 17 further comprising: a plurality of such at least one covers; wherein such plurality of such at least one covers comprise at least one set of covers. Additionally, it provides such a kit system according claim 18 wherein at least two members of such at least one set of covers comprise differing associating indicia. Also, it provides such a kit system according claim 16 further comprising at least one other cover structured and arranged to cover at least one other user accessory. In addition, it provides such a kit system according claim 16 further comprising such at least one earbud-type audio headphone.

In accordance with another preferred embodiment hereof, this invention provides a method related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, such method comprising the steps of: supplying at least one first cover comprising at least one substantially elastic outer membrane structured and arranged to substantially conform to at least one peripheral shape of the at least one speaker housing, wherein such at least one substantially flexible outer membrane defines at least one interior compartment, and wherein such at least one interior compartment comprises at least one access aperture structured and arranged to provide aperture access to such at least one interior compartment; passing at least one portion of the at least one inner-ear portion and the at least one outer-ear portion through such at least one access aperture to at least one position within such at least one interior compartment; and substantially covering the at least one earbud-type audio headphone by substantially containing the at least one inner-ear portion and the at least one outer-ear portion within such at least one interior compartment. And, it provides such a method further comprising the step of, applying to such at least one first cover, first associating indicia structured and arranged to visually associate such at least one cover to at least one other visual element.

Further, it provides such a method further comprising the steps of: removing such at least one first cover from the at least one earbud-type audio headphone; and covering the at least one earbud-type audio headphone with at least one second cover comprising at least one second associating indicia structured and arranged to visually associate such at least one cover to at least one other visual element.

In accordance with another preferred embodiment hereof, this invention provides a method related to the fabrication of at least one covering for at least one earbud-type audio headphone comprising at least one speaker housing having at least one inner-ear portion adapted to reside substantially within the inner ear of a user during use, and at least one outer-ear portion adapted to reside adjacent the outer ear of the user during use, such method comprising the steps of: providing at least one planar sheet of flexible, elastic material having at least one front face, at least one rear face, at least one top edge, and at least one bottom edge; folding such at least one planar sheet of flexible, elastic material along at least one first fold axis to place such at least one bottom edge in a position of contact with such at least one rear face, wherein such at least one first fold axis comprises an orientation substantially parallel to such at least one bottom edge.

In addition, it comprises the step of folding such at least one planar sheet of flexible, elastic material along at least one second fold axis to place at least one first front-face region of such at least one front face in at least one position of contact with at least one second front-face region of such at least one front face, wherein such at least one second fold axis is generally orthogonal to such at least one first fold axis; generating at least one flexible elastic pocket by forming at least one seam structured and arranged to join such at least one first front-face region to such at least one second front-face region, wherein such at least one seam comprises at least one seam path cutting such at least one flexible elastic pocket containing such at least one seam from such at least one planar sheet of flexible elastic material; producing at least one covering for at least one earbud-type audio headphone by inverting such at least one flexible elastic pocket to place such at least one first front-face region and such at least one second front-face region in external orientations.

Even further, it provides such a method wherein such at least one linear seam is formed by mechanical stitching using at least one thread. Even further, it provides such a method wherein such at least one linear seam intersects such at least one first fold axis and such at least one second fold axis.

Furthermore, it provides each and every novel feature, element, combination, step and/or method disclosed or suggested by this provisional patent application.

### BRIEF DESCRIPTION OF THE DRAWINGS

FIG. 1 shows a side view illustrating the use of an earbud protector of the earbud protection system according to a preferred embodiment of the present invention.

FIG. 2 shows a perspective view illustrating the installation of a set of earbud protectors onto a pair of earbud-type speakers, according to the preferred embodiment of FIG. 1.

FIG. 3 shows a perspective view of the earbud protector according to the preferred embodiment of FIG. 1.

FIG. 4 shows a front elevational view of the earbud protector of FIG. 1.

FIG. 5 shows the sectional view 5-5 of FIG. 4 according to the preferred embodiment of FIG. 1.

FIG. 6 shows the sectional view 6-6 of FIG. 2 according to the preferred embodiment of FIG. 1.

FIG. 7 shows a front elevational view illustrating an earbud protector of the earbud protection system according to another preferred embodiment of the present invention.

FIG. 8 shows a sectional view through a midline section of the preferred embodiment of FIG. 7.

FIG. 9 shows a front elevational view illustrating an earbud protector of the earbud protection system according to another preferred embodiment of the present invention.

FIG. 10 shows a front elevational view illustrating an earbud protector of the earbud protection system according to another preferred embodiment of the present invention.

FIG. 11 shows a front elevational view illustrating an earbud protector of the earbud protection system according to another alternate preferred embodiment of the present invention.

FIG. 12 shows a front elevational view, illustrating an earbud protector of the earbud protection system with applied indicia, according to another preferred embodiment of the present invention.

FIG. 13 shows a perspective view illustrating the installation of a set of earbud protectors onto a pair of earbud-type speakers, according to a preferred embodiment of FIG. 12.

FIG. 14 shows a diagram illustrating a kit system, of the earbud protection system, according to another preferred embodiment of the present invention.

FIG. 15 through FIG. 21 show a series of diagrams generally illustrating preferred steps in the fabrication of an earbud protector of the earbud protection system, according to a preferred method of the present invention.

### DETAILED DESCRIPTION OF THE BEST MODES AND PREFERRED EMBODIMENTS OF THE INVENTION

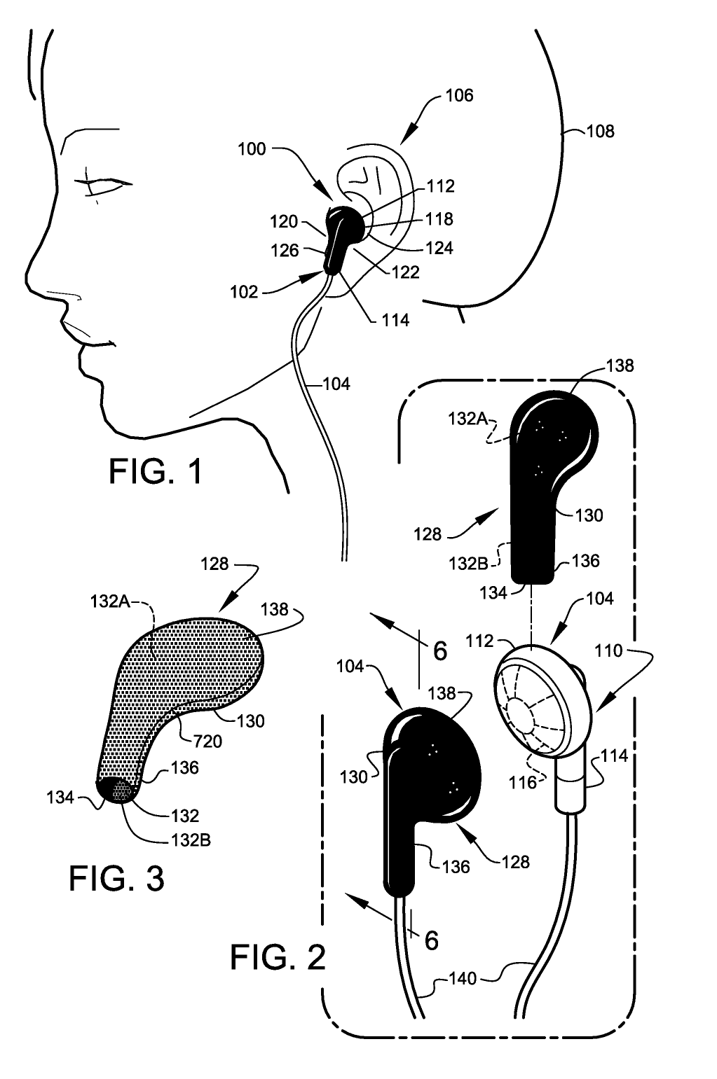

FIG. 1 shows a side view illustrating the application and use of earbud protector 102 of earbud protection system 100, according to a preferred embodiment of the present invention. FIG. 2 shows a perspective view illustrating the installation of earbud protectors 102 onto a pair of earbud speakers 104, according to the preferred embodiment of FIG. 1.

The depicted earbud speakers 104 (at least embodying herein at least one earbud-type audio headphone) of FIG. 1 and FIG. 2 comprise a type compatible with commercially available portable audio systems, mobile phones, and similar devices that require a user/device audio-interface, as shown. Preferably, earbud protector 102 is structured and arranged to provide an external covering over substantially the entire outer housing 110 (see FIG. 2) of earbud speaker 104, as shown. Earbud protector 102 preferably assists in providing a comfortable and secure fit, of earbud speaker 104, within ear 106 of user 108, as shown. Preferably, earbud protector 102 is adapted for use as a cover dressing for a broad range of manufactured earbud systems.

Typically, outer housing 110 of earbud speaker 104 comprises two principal portions, identified herein as inner-ear portion 112 and outer-ear portion 114, as shown. Typically, inner-ear portion 112 houses the sound-generating speaker module 116, depicted by the dashed-line indication of the rightmost earbud speaker 104 of FIG. 2.

During use, earbud speaker 104 is placed within ear 106 of user 108, as shown. More specifically, inner-ear portion 112 of earbud speaker 104 is placed within ear concha 118 of ear 106, as shown. Generally, inner-ear portion 112 is held within ear concha 118 by frictional pressure imparted by ear tragus 120, ear antitragus 122, and ear antihelix 124, as shown. During use, a majority of outer-ear portion 114 remains outside the structures of ear 106, as shown. In the depicted example of FIG. 1, outer-ear portion 114 rests outside ear concha 118, adjacent ear intertragic notch 126, as shown.

Typically, outer housing 110 of earbud speaker 104 comprises a rigid material such as hard plastic. Users often find retention of a bare earbud speaker 104 within ear 106 both difficult and uncomfortable.

FIG. 3 shows a perspective view of earbud protector 102, according to the preferred embodiment of FIG. 1. Reference is now made to the illustration of FIG. 3, with continued reference to FIG. 1 and FIG. 2. Preferably, earbud protector 102 is adapted to cover substantially the entire inner-ear portion 112 and at least a substantial part of outer-ear portion 114 of outer housing 110, as shown.

Preferably, earbud protector 102 comprises a substantially flexible outer membrane 130, forming at least one expandable interior compartment 132, as shown (at least embodying herein at least one interior compartment structured and arranged to interiorly contain at least one portion of both the at least one inner-ear portion and the at least one outer-ear portion; and further comprising wherein such at least one interior compartment comprises at least one substantially flexible outer membrane structured and arranged to substantially surrounds such at least one interior compartment).

Preferably, earbud protector 102 comprises a generally elongated, flexible sleeve having a lower open end 136 and an upper closed end 138, as shown. Preferably, earbud protector 102 comprises a generally preformed shape, as shown. Preferably, earbud protector 102 comprises a pre-formed shape generally matching the outer shape of outer housing 110, as shown (at least embodying herein at least one shape conformer structured and arranged to substantially conform such at least one cover to at least one outer shape of the at least one speaker housing; and further comprising wherein such at least one cover further comprises a least one pre-formed shape structured and arranged to generally match at least one outer shape of the at least one inner-ear portion and the at least one outer-ear portion). Preferably, earbud protector 102 comprises a shape somewhat resembling the Greek letter Rho “ρ”, as shown (at least embodying herein wherein such at least one cover is generally shaped to match at least one outer shape of such at least one earbud-type audio headphone).

Preferably, interior compartment 132 of earbud protector 102 is divided into an enlarged upper interior compartment 132A smoothly transitioning to a relatively narrow lower interior compartment 132B, as shown. Preferably, upper interior compartment 132A is adapted to accommodate the generally disc-shaped inner-ear portion 112, of earbud speakers 104, as shown (at least embodying herein at least one first region within such at least one interior compartment structured and arranged to generally match at least one outer shape of the at least one inner-ear portion of the at least one earbud-type audio headphone). Preferably, lower interior compartment 132B is adapted to accommodate the smaller generally cylindrical outer-ear portion 114, as shown (at least embodying herein at least one second region within such at least one interior compartment structured and arranged to generally match at least one outer shape of the at least one outer-ear portion of the at least one earbud-type audio headphone).

Preferably, access to interior compartment 132 is provided by means of an expandable access aperture 134, as shown (at least embodying herein at least one access aperture structured and arranged to provide aperture access to such at least one interior compartment). Preferably, access aperture 134 extends through outer membrane 130 of open end 136 to provide a passage to the distal end of lower interior compartment 132B, as shown.

Preferably, installation of earbud protector 102 over earbud speaker 104 is facilitated by the novel shapes, structures, and material arrangements of outer housing 110. Preferably, to install earbud protector 102 over earbud speaker 104, user 108 places access aperture 134 adjacent inner-ear portion 112 and draws earbud protector 102 over earbud speaker 104. The preferred elastic quality of outer membrane 130 allows outer-ear portion 114 to pass through lower interior compartment 132B to reside within upper interior compartment 132A, as shown in FIG. 2. Preferably, earbud protector 102 conforms itself directly over the outer peripheral contours of earbud speakers 104, clinging to the major aspects of the shape. Preferably, earbud protector 102 is readily removable from earbud speakers 104, thus allowing the user to substitute earbud protector 102 with a unit comprising an alternate color or design.

Thus, it is noted that in accordance with another preferred embodiment hereof, this invention provides at least one method, related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, such method comprising the steps of: supplying at least one first cover comprising at least one substantially elastic outer membrane adapted to substantially conform to at least one peripheral shape of the at least one speaker housing; wherein such at least one substantially flexible outer membrane defines at least one interior compartment; and wherein such at least one interior compartment comprises at least one access aperture adapted to provide aperture access to such at least one interior compartment; passing at least one portion of the at least one inner-ear portion and the at least one outer-ear portion through such at least one access aperture to at least one position within such at least one interior compartment; and substantially covering the at least one earbud-type audio headphone by substantially containing the at least one inner-ear portion and the at least one outer-ear portion within such at least one interior compartment.

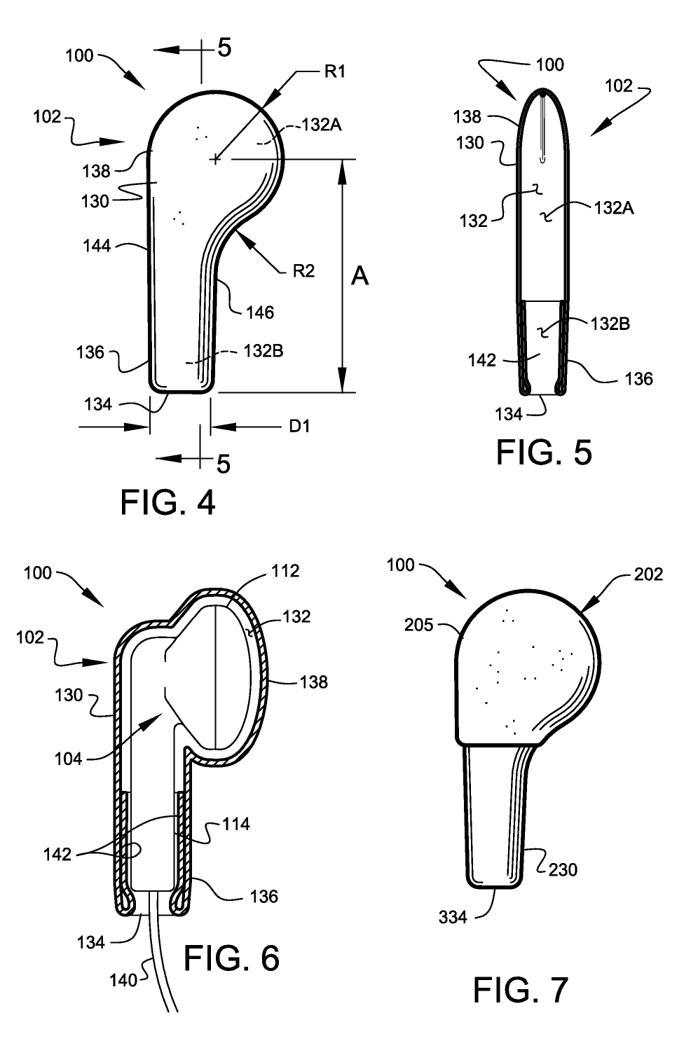

FIG. 4 shows a front elevational view of earbud protector 102 of FIG. 1. Earbud protector 102, as depicted in FIG. 4, is preferably suitable for covering a diverse range of earbud designs. The preferred elastic quality of earbud protector 102 is sufficiently adaptable as to provide essentially a “one-size-fits all” cover system.

In addition, highly preferred embodiments of earbud protection system 100 comprise physical features keyed to a specific commercial brand or manufactured line of earbud speakers 104. For example, the earbud protector 102 of FIG. 4 is specifically adapted (in size, shape, color, etc.) to cover earbud speakers 104 produced by Apple Corporation U.S.A. for the Ipod® line of portable media devices, as shown.

Preferably, the earbud protector 102 of FIG. 4 comprises a partial disk-shaped closed end 138 having a radius R1 of about one-quarter inch, as shown. The center point of radius R1 is located above access aperture 134 a distance A of about seven-eighths inch, as shown. Open end 136 preferably comprises a hollow cylindrical shape having a diameter D1 of about one-quarter inch, as shown. In the front elevational view of FIG. 4, a folded side edge 144 of open end 136 (the left edge boundary of earbud protector 102) is about tangent with the outer circumference of closed end 138, intersecting at a point on the outer circumference about equal to the vertical distance A above access aperture 134, as shown. Preferably, a seamed side edge 146 (the right edge boundary of open end 136) smoothly transitions into the lower circumferential edge of closed end 138, preferably following a convex curve, tangent to both side edge 146 and closed end 138, having a preferred radius R2 of about one-quarter inch, as shown.

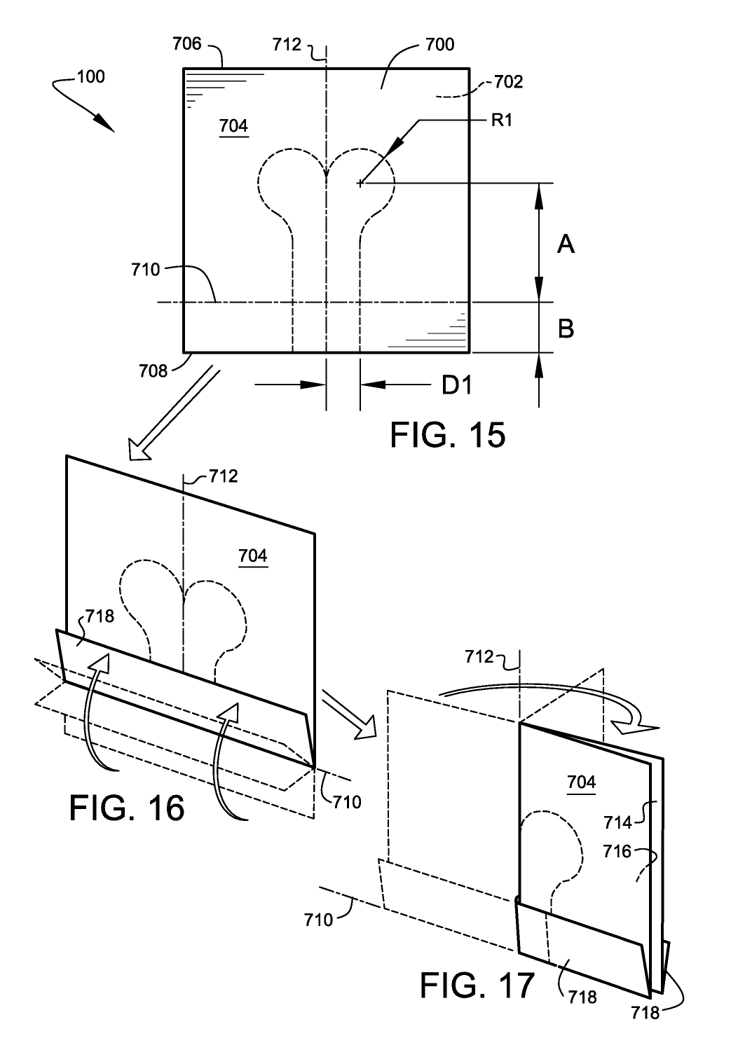

FIG. 5 shows the sectional view 5-5 of FIG. 4 according to the preferred embodiment of FIG. 1. FIG. 6 shows the sectional view 6-6 of FIG. 2, illustrating earbud protector 102 substantially enveloping both the disk-shaped inner-ear portion 112 and cylindrical outer-ear portion 114 of earbud speakers 104. FIG. 6 clearly illustrates the substantial enveloping of outer housing 110, including at least one preferred embodiment extending to cover a portion of speaker wire 140, as shown (at least embodying herein wherein such at least one interior compartment is structured and arranged to cover at least one portion of at least one external wire adapted to conduct electrical signals externally of the at least one speaker housing; and wherein such at least one interior compartment is structured and arranged to cover at least one portion of such at least one wire). Preferably, this extensive coverage arrangement assists in firmly retaining earbud protector 102 on earbud speaker 104. The retention of earbud protector 102 on earbud speaker 104 is further assisted by the incorporation of a novel friction band 142 preferably located within lower interior compartment 132B, as shown (at least embodying herein at least one frictional retainer structured and arranged to assist frictional retention of such at least one cover on the at least one earbud-type audio headphone; wherein such at least one frictional retainer comprises at least one friction-generating band structured and arranged to frictionally engage at least one outer circumferential surface of the at least one outer-ear portion). A preferred method of producing friction band 142 within open end 136 is described in the fabrication illustrations of FIG. 15 through FIG. 21. The preferred retention feature of friction band 142 is especially useful in preferred embodiments of earbud protector 102 that do not fully envelope the length of outer-ear portion 114.

Preferably, the expandable interior compartment 132 is sized so that it tightly envelops earbud speaker 104, without exceeding the elastic limits of outer membrane 130 (for clarity, outer membrane 130 is shown spaced a distance away from earbud speaker 104; in actual use, both are in close contact). Preferably, outer membrane 130 comprises a material that can be stretched repeatedly while recovering its original physical shape. Furthermore, outer membrane 130 preferably comprises a material that can be stretched repeatedly in at least four directions. Preferably, outer membrane 130 comprises at least one elastomeric material that is relatively lightweight, soft (non-abrasive over extended periods of skin contact), and thermally stable when cured. Preferably, outer membrane 130 comprises a composition that is substantially resistant to minor abrasion and deterioration by body oils, perspiration, lotions and detergents. Preferably, outer membrane 130 comprises a composition that is relatively sound permeable thus allowing the sound generated by ear bud speakers 104 to propagate through outer membrane 130 (at least embodying herein at least one sound-wave propagator structured and arranged to propagate at least one portion of the at least one audible sound wave through such at least one cover).

Preferred embodiments of earbud protector 102 are constructed from a generally planar material, preferably a flexible planar sheet comprising the 4-way elastic quality (as described above). In a highly preferred embodiment, earbud protector 102 is preferably constructed from at least one woven elastic textile fabric, preferably comprising at least one made-made (synthetic) fiber. Woven fabric embodiments of earbud protector 102 more preferably comprise an elastic Spandex Fiber (Elastane). In the United States, Spandex fibers are currently produced by a number of manufacturers including: Dorlastan Fibers LLC (formerly Bayer Corp.), Invista Inc. (under the brand name Lycra®), and RadiciSpandex Corporation.

Most preferably, outer membrane 130 comprises an elastic Spandex/Lycra® textile commonly marketed under the name Milliskin (at least embodying herein wherein such at least one substantially flexible outer membrane comprises at least one substantially elastic fabric). Upon reading the teachings of this specification, those of ordinary skill in the art will now understand that, under appropriate circumstances, considering such issues as user preference, intended use, cost, etc., other fabrics/fiber combinations, such as, for example, composite blends of nylons, polyesters, cottons, etc., may suffice.

Alternately, preferred embodiments of outer membrane 130 are constructed from a commercially available neoprene sheet material having at least one fabric facing. Such embodiments of earbud protector 102 are preferably constructed from a single neoprene sheet that preferably comprises a novel folded configuration secured by thermal bonding or mechanical sewing (see FIG. 15 through FIG. 21). Upon reading the teachings of this specification, those with ordinary skill in the art will now understand that, under appropriate circumstances, considering issues such as cost, intended use, etc., other fabrication arrangements, such as, for example, thermal shaping of sheets, die cutting, stamping, etc., may suffice.

Alternately, preferred embodiments of outer membrane 130 are formed from at least one synthetic rubber using an injection molding process (at least embodying herein wherein such at least one substantially flexible outer membrane comprises at least one molded unit comprising at least one synthetic rubber). Preferably, a polychloroprene-based synthetic rubber is used with Neoprene (CR) rubber being most preferred. With injection molding, various levels of quality can be produced utilizing various materials and manufacturing techniques, to produce long lasting specialty earbuds, or short-term disposable embodiments of earbud protection system 100. Upon reading the teachings of this specification, those of ordinary skill in the art will now understand that, under appropriate circumstances, considering such issues as intended use, disposability, complexity of earbud design, etc., other fabrication methods, such as, compression molding, transfer molding, dip molding, etc., may suffice, especially in the production of disposable embodiments of the present invention.

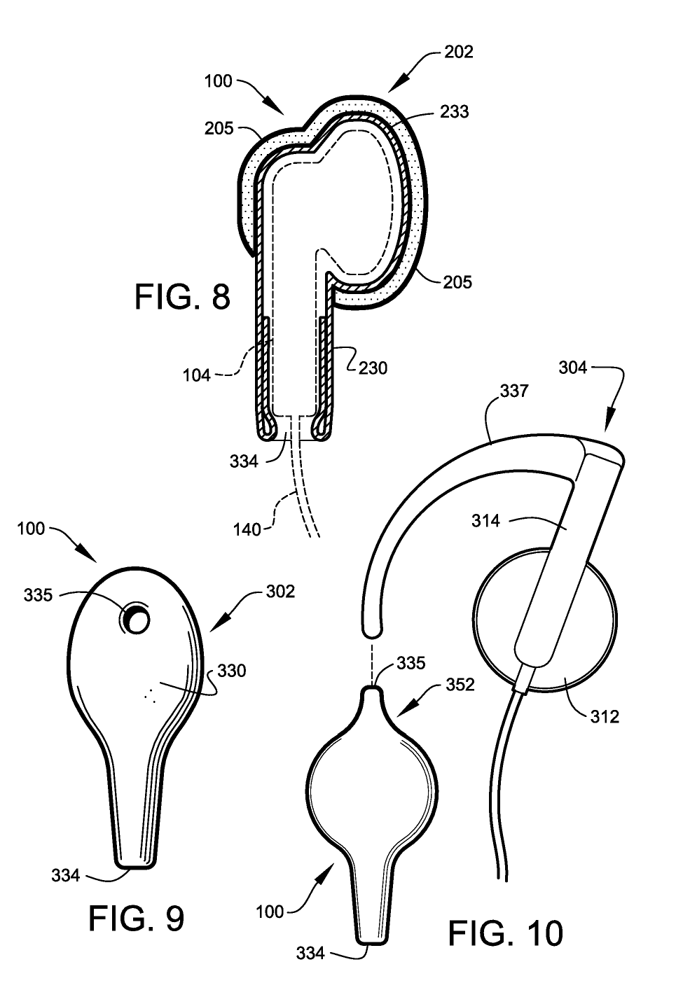

FIG. 7 shows a front elevational view illustrating earbud protector 202 of the earbud protection system 100 according to another preferred embodiment of the present invention. FIG. 8 shows a sectional view through a midline section of the preferred embodiment of FIG. 7. Preferably, earbud protector 202 is substantially similar in arrangement to that of earbud protector 102, however; earbud protector 202 is modified such that outer membrane 230 of closed end 238 comprises an additional protective layer of foam 205, as shown. Preferably, foam 205 is permanently joined to outer membrane 230, preferably by bonding, most preferably by sewing. Preferably, foam 205 (at least embodying herein wherein such at least one substantially flexible outer membrane comprises at least one outer foam covering structured and arranged to externally cover at least one portion of the at least one inner-ear portion) comprises lightweight open-cell foam material.

FIG. 9 shows a front elevational view illustrating an earbud protector 302 of the earbud protection system 100 according to another preferred embodiment of the present invention. Preferably, earbud protector 302 is substantially similar in arrangement to that of earbud protector 102, however; earbud protector 302 is modified such that outer membrane 330 comprises an opening at both upper and lower ends, as shown. Preferably, earbud protector 302 comprises lower access aperture 334 and upper aperture 335, as shown. Preferably, upper aperture 335 comprises a small rounded hole that preferably provides a passage for the propagation of sound, when installed for use, thus preventing loss of sound volume and/or quality (at least embodying herein wherein such at least one sound-wave propagator comprises at least one sound passing aperture adapted to assist passage of the at least one audible sound wave through such at least one substantially flexible outer membrane).

FIG. 10 shows a front elevational view illustrating earbud protector 352 of earbud protection system 100 according to another preferred embodiment of the present invention. Preferably, earbud protector 352 is adapted to protectively cover alternate earbud 304. Alternate earbud 304 comprises an additional ear support structure 337, as shown. Structure 337 extends outwardly from outer-ear portion 314 and is adapted to wrap around the ear of the wearer. Preferably, the combination of lower access aperture 334 and upper aperture 335 allows earbud protector 352 to be installed over substantially all of inner-ear portion 312 and outer-ear portion 314 of alternate earbud 304, as shown.

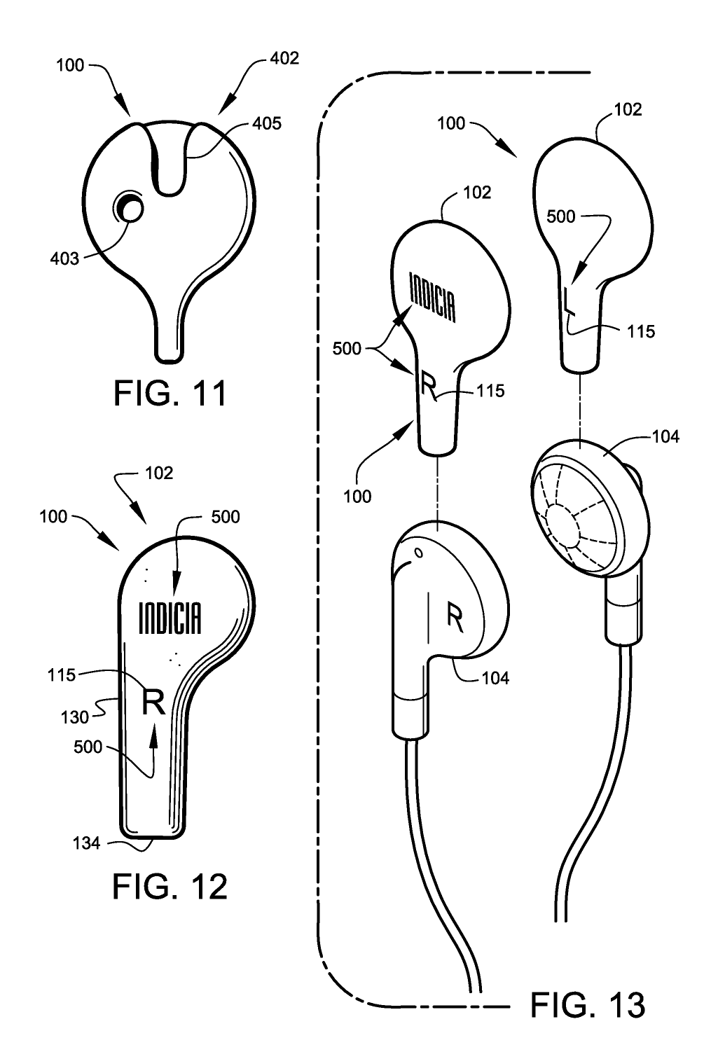

FIG. 11 shows a front elevational view illustrating earbud protector 402 of the earbud protection system 100 according to another alternate preferred embodiment of the present invention. As previously described, preferred embodiments of earbud protection system 100 comprise physical features keyed to a specific commercial brand or manufactured line of earbud speakers 104. For example, earbud protector 402 of FIG. 11 is adapted to accommodate the unique physical structures of a specific earbud-type speaker design. Such unique adaptations preferably include positioned apertures 403, shaped apertures 405, earbud specific aperture sizing, etc. In addition, preferred embodiments of earbud protection system 100 comprise nonstandard lengths, wherein the length of the earbud protector varies to accommodate multiple sizes/lengths of earbud speakers 104.

FIG. 12 shows a front elevational view, illustrating earbud protector 102 of the earbud protection system 100, comprising indicia 500, according to another preferred embodiment of the present invention. Preferably, earbud protector 102 can be used functionally as apparel or as an extended apparel statement. Preferably, indicia 500 are used to associate earbud protector 102 with at least one other visual element, such as, for example, a company logo, a product brand, a sports team logo, etc. (at least embodying herein wherein such at least one cover further comprises associating indicia structured and arranged to visually associate such at least one cover to at least one other visual element). Other preferred examples of indicia 500 include such design elements as colors, patterns, fashion logos, statement logos, picture logos (such as a skull & crossbones, dolphins, skateboards), etc. Thus, earbud protection system 100 preferably provides an inexpensive means of advertising that can be utilized in trade show marketing, exhibits, company information meetings, etc.

Preferably, earbud protection system 100 is suitable for use as original equipment parts, supplied to the consumer by companies producing audio/media devices. Preferred embodiments of earbud protection system 100 comprise both an earbud protector and earbud speaker 104, as shown (at least embodying herein such at least one earbud-type audio headphone). Upon reading the teachings of this specification, those with ordinary skill in the art will now understand that, under appropriate circumstances, considering issues such as intended market, speaker system design, etc., other cover/earbud arrangements, such as, for example, permanently bonding the cover to the ear-bud housing, mechanically fastening the cover to the ear-bud housing, etc., may suffice.

FIG. 13 shows a perspective view illustrating the installation of a set of earbud protectors 102, onto a pair of earbud speakers 104, according to a preferred embodiment of FIG. 12. Preferably, indicia 500 further comprises functional markings 115, such as the depicted “R” (right earbud) and “L” (left earbud) markings, generally associating earbud protectors 102 with the corresponding visual markings of earbud speakers 104.

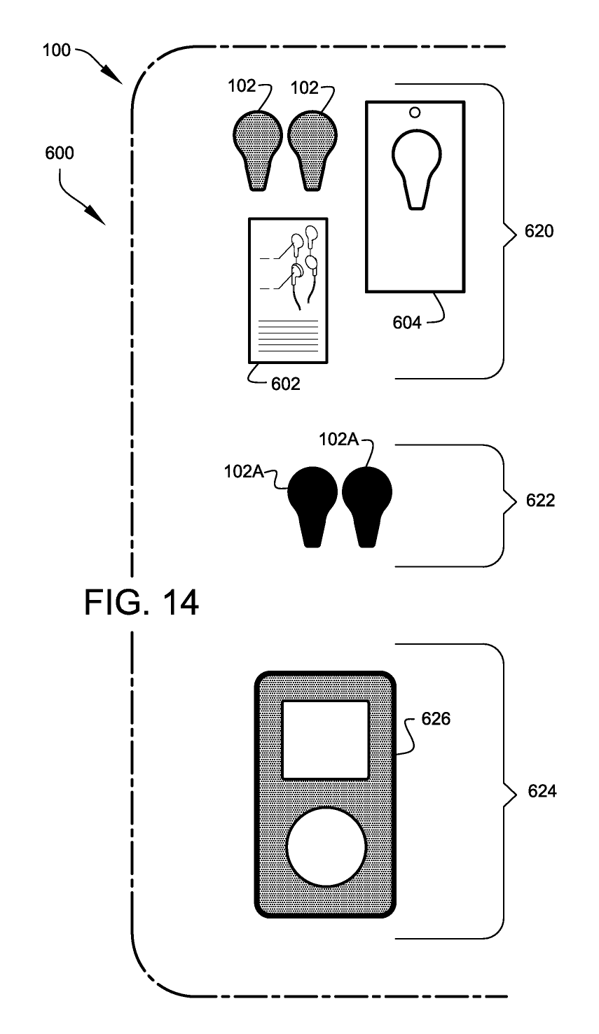

FIG. 14 shows a diagram illustrating kit system 600, of earbud protection system 100, according to an additional preferred embodiment of the present invention. Preferably, kit system provides a convenient assemblage of components necessary to retrofit the components of earbud protection system 100 to an earbud-type speaker of an audio/media device. Basic kit 620 of kit system 600 preferably comprises at least one earbud protector 102, instructions for use 602, and packaging 604, as shown. Kit systems 600 adapted for audio/media devices having two earbuds (stereo units) preferably comprise two earbud protectors 102, as shown.

Preferably, expanded kit 622 of kit systems 600 adds to basic kit 620 an additional set of earbud protectors 102A, as shown. Preferably, earbud protectors 102A of expanded kit 622 are preferably adaptable to provide additional color, logo, and/or theme options.

Preferably, expanded kit 624 of kit systems 600 adds to basic kit 620 at least one additional accessory 626, preferably a visually coordinated accessory cover, as shown (at least embodying herein at least one other cover adapted to cover at least one other user accessory). Example accessories 626 include coordinated storage cases, coordinated player device covers, etc., as shown.

Preferably, each of the above-described kit embodiments is adaptable to comprise coordinating indicia, such as, for example, the coordinating colors of earbud protectors 102A. Preferably, such coordinating indicia is structured and arranged to visually coordinate the earbud protectors with indicia associated with at least one other visual element. For example, such coordinating indicia may generally match a school color, a popular logo or icon, the markings of a favorite sports team, etc.

Preferably, packaging 604 of kit system 600 is adapted for retail sale in retail store displays. For example, kit system 600 is preferably adapted for retail sale within mall accessory kiosks where apparel related and standard color replacements of earbud protection system 100 would be purchasable, preferably on a single-pair or multiple-unit quantity basis (in multiple colors and in multiple visually coordinated styles).

Upon reading the teachings of this specification, those with ordinary skill in the art will now understand that, under appropriate circumstances, considering issues such as, intended use, target pricing, device type etc., other kit arrangements, such as, for example, providing kits comprising: single earbud protectors, earbud protector pairs, multiple earbud protector pairs, single or multiple earbud protectors comprising one or more color themes/logos, ordered kits of custom composition, sale of kit through the Internet, etc., may suffice.

FIG. 15 through FIG. 21 show a series of assembly diagrams generally illustrating preferred steps in the fabrication of earbud protector 102 of earbud protection system 100, according to a preferred method of the present invention. Although the described method enables the fabrication of a single earbud cover, those skilled in the art, on reviewing the present teachings, will now appreciate that the basic fabrication techniques are applicable to larger volume assembly procedures. FIG. 15 illustrates the initial step in fabricating earbud protector 102. The initial fabrication step begins with a planar sheet of flexible, elastic material 700 having at least one front face 702, at least one rear face 704, at least one top edge 706, and at least one bottom edge 708, as shown. Elastic material 700 will produce outer membrane 130 and therefore most preferably comprises an elastic Spandex/Lycra® textile (a dashed outline indicating the general area of material that will be used to fabricate earbud protector 102 is shown to assist in the teachings below).

In the next preferred step, elastic material 700 is folded along first fold axis 710 to place bottom edge 708 in a position of contact with rear face 704, as best illustrated in FIG. 17. Preferably, first fold axis 710 comprises an orientation substantially parallel to bottom edge 708, as shown. Preferably, first fold axis 710 is located above bottom edge 708 a distance B of about three-eighth inch. Preferably, the initial fold produces an additional layer of elastic material identified herein as band 718. Preferably, band 718 will eventually form the internal friction band 142 of lower interior compartment 132B.

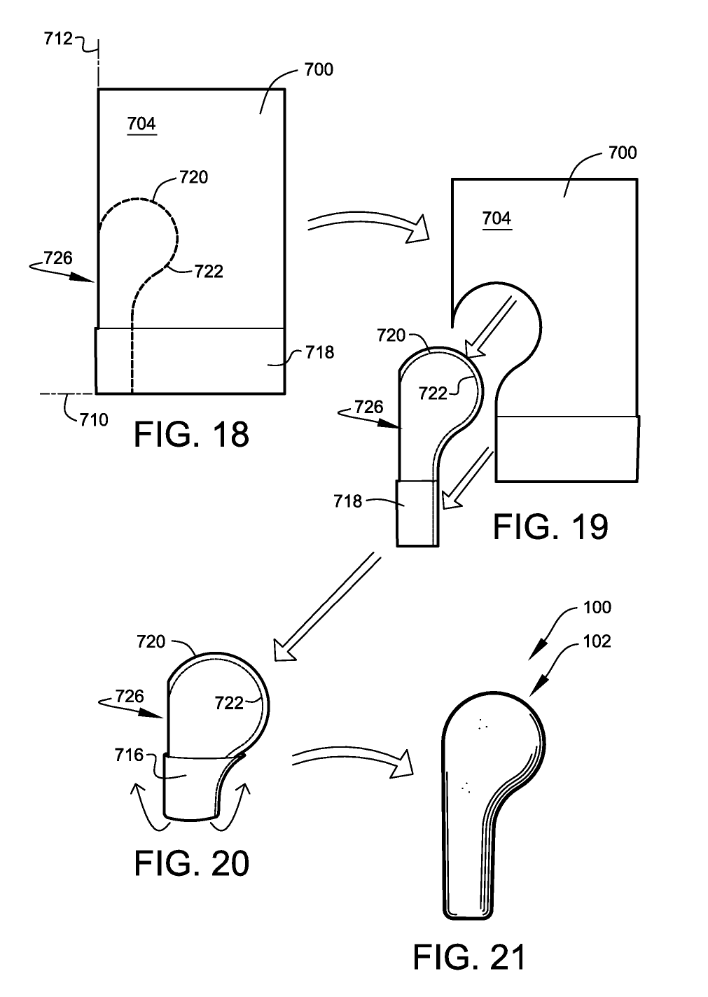

FIG. 18 illustrates a subsequent preferred step wherein elastic material 700 is folded along second fold axis 712 to place a first front-face region 714 of front face 702 in a position of contact with a second front-face region 716 of front face 702, as shown. Preferably, second fold axis 712 is generally orthogonal to first fold axis 714, as shown. It should be noted that, in general, FIG. 16 and FIG. 17 are sequentially interchangeable fabrication steps, ordered by preference of the fabricator.

Preferably, earbud pocket 726 (at least embodying herein at least one flexible elastic pocket) is preferably formed by joining first front-face region 714 to second front-face region 716, as shown in FIG. 18. Preferably, first front-face region 714 is permanently joined to second front-face region 716 using seam 720, applied along a predefined seam path 722, as shown in FIG. 18. Preferably, seam path 722 generally follows the outer peripheral shape of earbud protector 102, as shown. Preferably, seam 720 extends from about first fold axis 710 to about second fold axis 712, as shown. Upon reading the teachings of this specification, those of ordinary skill in the art will now understand that, under appropriate circumstances, considering such issues as intended use, application, etc., other seam arrangements, such as, for example, starting and stopping the seam to form additional access apertures, etc., may suffice.

Preferably, seam 720 is formed by mechanical sewing using at least one compatible thread and at least one stitch compatible with elastic fabric. Upon reading the teachings of this specification, those of ordinary skill in the art will now understand that, under appropriate circumstances, considering such issues as intended use, material selection, advances in technology, cost, etc., other seaming arrangements, such as, for example, thermal bonding, adhesive bonding, cutting and removal of the pocket prior to the application of an overlock or similar stitch, etc., may suffice.

FIG. 19 illustrates the removal of the seamed earbud pocket 726 from the folded panel of elastic material 700. Preferably, the seamed earbud pocket 726 is removed from elastic material 700 by cutting elastic material 700 just beyond seam path 722, as shown. Preferably, the cutting step is preformed using common textile processes preferably including the use of rotary dies, rotary dies with heating, and/or using appropriately shaped cutting dies. Upon reading the teachings of this specification, those of ordinary skill in the art will now understand that, under appropriate circumstances, considering such issues as intended use, advances in technology, cost, etc., other cutting arrangements, such as, for example, the use of computer controlled cutters, lasers, manual cutting using guide patterns, etc., may suffice.

In the preferred step illustrated in FIG. 20, the seamed earbud pocket 726 is inverted to place first front-face region 714 and second front-face region 716 in an external orientation. FIG. 21 shows the preferred final product after the inverting step. Upon reading the teachings of this specification, those of ordinary skill in the art will now understand that, under appropriate circumstances, considering such issues as intended use, cost, etc., additional steps, such as, for example, applying indicia, packaging, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above

Further, many other advantages of applicant's invention will be apparent to those skilled in the art from the above descriptions and the below claims.

What is claimed is:

1) A system related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, said system comprising:
a) at least one cover structured and arranged to cover substantially the entire at least one inner-ear portion and the at least one outer-ear portion of the at least one speaker housing;
b) wherein said at least one cover comprises
i) at least one interior compartment structured and arranged to interiorly contain at least one portion of both the at least one inner-ear portion and the at least one outer-ear portion,
ii) at least one access aperture structured and arranged to provide aperture access to said at least one interior compartment,
iii) at least one shape conformer structured and arranged to substantially conform said at least one cover to at least one outer shape of the at least one speaker housing, and
iv) at least one sound-wave propagator structured and arranged to propagate at least one portion of at least one audible sound wave through said at least one cover.

2) The system according to claim 1 wherein said at least one interior compartment is structured and arranged to cover at least one portion of at least one external wire adapted to conduct electrical signals externally of the at least one speaker housing.

3) The system according to claim 1 wherein said at least one interior compartment comprises at least one substantially flexible outer membrane structured and arranged to substantially surround said at least one interior compartment.

4) The system according to claim 1 wherein said at least one sound-wave propagator comprises at least one sound passing aperture structured and arranged to assist passage of at least one audible sound wave through said at least one substantially flexible outer membrane.

5) The system according to claim 3 wherein said at least one substantially flexible outer membrane comprises at least one molded unit comprising at least one synthetic rubber.

6) The system according to claim 3 wherein said at least one substantially flexible outer membrane comprises at least one substantially elastic fabric.

7) The system according to claim 3 wherein said at least one substantially flexible outer membrane comprises at least one outer foam covering structured and arranged to externally cover at least one portion of the at least one inner-ear portion.

8) The system according to claim 1 wherein said at least one cover further comprises a least one pre-formed shape structured and arranged to generally match at least one outer shape of the at least one inner-ear portion and the at least one outer-ear portion.

9) The system according to claim 1 wherein said at least one cover further comprises associating indicia structured and arranged to visually associate said at least one cover to at least one other visual element.

10) A system related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, said system comprising:
a) at least one cover structured and arranged to substantially cover the at least one inner-ear portion and the at least one outer-ear portion of the at least one speaker housing;
b) wherein said at least one cover comprises at least one substantially elastic outer membrane structured and arranged to substantially conform to at least one peripheral shape of the at least one speaker housing;
c) wherein said at least one substantially flexible outer membrane comprises at least one interior compartment; and
d) wherein said at least one interior compartment comprises at least one access aperture structured and arranged to provide aperture access to said at least one interior compartment.

11) The system according to claim 10 wherein:
a) said at least one cover comprises at least one pre-formed shape structured and arranged to generally match at least one outer shape of such at least one earbud-type audio headphone;
b) said at least one pre-formed shape comprises
i) within said at least one interior compartment, at least one first region structured and arranged to generally match at least one outer shape of the at least one inner-ear portion of the at least one earbud-type audio headphone; and
ii) within said at least one interior compartment, at least one second region structured and arranged to generally match at least one outer shape of the at least one outer-ear portion of the at least one earbud-type audio headphone.

12) The system according to claim 11 wherein said at least one first region is structured and arrange to conform to at least one substantially circular shape having an outer radius of about one-quarter inch.

13) The system according to claim 11 wherein said at least one second region is structured and arrange to conform to at least one substantially cylindrical shape having an outer diameter of about one-quarter inch.

14) The system according to claim 13 wherein:
a) said at least one second region further comprises at least one frictional retainer structured and arranged to assist frictional retention of said at least one cover on the at least one earbud-type audio headphone; and
b) said at least one frictional retainer comprises at least one friction-generating band structured and arranged to frictionally engage at least one outer circumferential surface of the at least one outer-ear portion.

15) The system according to claim 10 further comprising such at least one earbud-type audio headphone.

16) A kit system related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, said kit system comprising:
a) at least one cover structured and arranged to substantially cover the at least one inner-ear portion and the at least one outer-ear portion of the at least one speaker housing;
b) at least one set of user instructions; and
c) at least one package structured and arranged to contain said at least one cover and said at least one set of user instructions;
d) wherein said at least one cover comprises
i) at least one interior compartment structured and arranged to interiorly receive at least one substantial portion of the at least one inner-ear portion and at least one portion of the at least one outer-ear portion,
ii) at least one access aperture structured and arranged to provide aperture access to said at least one interior compartment,
iii) at least one shape conformer structured and arranged to substantially conform said at least one cover to at least one outer shape of the at least one speaker housing, and
iv) at least one sound-wave propagator structured and arranged to propagate at least one portion of the at least one audible sound wave through said at least one cover.

17) The kit system according claim 16 wherein said at least one cover further comprises coordinating indicia structured and arranged to visually coordinate said at least one cover to indicia associated with at least one other visual element.

18) The kit system according claim 17 further comprising:
a) at least one set of covers;
b) wherein at least one member of said at least one set of covers comprises said at least one covers.

19) The kit system according claim 18 wherein at least two members of said at least one set of covers comprise differing said coordinating indicia.

20) The kit system according claim 16 further comprising at least one other cover structured and arranged to cover at least one other user accessory.

21) The kit system according claim 16 further comprising such at least one earbud-type audio headphone.

22) A method related to covering at least one earbud-type audio headphone comprising at least one speaker housing having at least one inner-ear portion adapted to reside substantially within the inner ear of a user during use, and at least one outer-ear portion adapted to reside adjacent the outer ear of the user during use, such method comprising the steps of:
a) supplying at least one first cover comprising
i) at least one substantially elastic outer membrane structured and arranged to substantially conform to at least one peripheral shape of the at least one speaker housing,
ii) wherein such at least one substantially flexible outer membrane comprises at least one interior compartment, and
iii) wherein such at least one interior compartment comprises at least one access aperture structured and arranged to provide aperture access to such at least one interior compartment;
b) passing at least one portion of the at least one inner-ear portion and at least one portion of the at least one outer-ear portion through such at least one access aperture to at least one position within such at least one interior compartment; and
c) substantially covering the at least one earbud-type audio headphone by substantially containing the at least one inner-ear portion and the at least one outer-ear portion within such at least one interior compartment.

23) The method according to claim 22 further comprising the step of, applying to such at least one first cover, first associating indicia structured and arranged to visually associate said at least one cover to at least one other visual element.

24) The method according to claim 23 further comprising the steps of:
a) removing such at least one first cover from the at least one earbud-type audio headphone; and
b) covering the at least one earbud-type audio headphone with at least one second cover comprising at least one second associating indicia structured and arranged to visually associate said at least one cover to at least one other visual element.

25) A method related to the fabrication of at least one covering for at least one earbud-type audio headphone comprising at least one speaker housing having at least one inner-ear portion adapted to reside substantially within the inner ear of a user during use, and at least one outer-ear portion adapted to reside adjacent the outer ear of the user during use, such method comprising the steps of:
a) providing at least one planar sheet of elastic material having at least one front face, at least one rear face, at least one top edge, and at least one bottom edge;
b) folding such at least one planar sheet of elastic material along at least one first fold axis to place such at least one bottom edge in a position of contact with such at least one rear face, wherein such at least one first fold axis comprises an orientation substantially parallel to such at least one bottom edge;
c) folding such at least one planar sheet of elastic material along at least one second fold axis to place at least one first front-face region of such at least one front face in at least one position of contact with at least one second front-face region of such at least one front face, wherein such at least one second fold axis is generally orthogonal to such at least one first fold axis;
d) generating at least one flexible elastic pocket by forming at least one seam structured and arranged to join such at least one first front-face region to such at least one second front-face region, wherein such at least one seam comprises at least one seam path;
e) cutting such at least one flexible elastic pocket containing such at least one seam from such at least one planar sheet of elastic material; and
f) producing at least one covering for at least one earbud-type audio headphone by inverting such at least one flexible elastic pocket to place such at least one first front-face region and such at least one second front-face region in external orientations.

26) The method according to claim 25 wherein such at least one linear seam is formed by mechanical stitching using at least one thread.

27) The method according to claim 25 wherein such at least one linear seam intersects such at least one first fold axis and such at least one second fold axis.
